(19) United States
(12) Patent Application Publication
(10) Pub. No.: US 2020/0313207 A1
(43) Pub. Date: Oct. 1, 2020

(54) SOLID OXIDE FUEL CELL PLACEMENT IN GAS TURBINE COMBUSTOR

(71) Applicants: Ryan Milcarek, Gilbert, AZ (US); Rhushikesh Ghotkar, Tempe, AZ (US)

(72) Inventors: Ryan Milcarek, Gilbert, AZ (US); Rhushikesh Ghotkar, Tempe, AZ (US)

(21) Appl. No.: 16/829,476

(22) Filed: Mar. 25, 2020

Related U.S. Application Data
(60) Provisional application No. 62/823,302, filed on Mar. 25, 2019.

(51) Int. Cl. H01M 8/04111; H01M 8/04014; H01M 8/0612; H01M 8/1233

(52) U.S. Cl. CPC H01M 8/04111; H01M 8/04022; H01M 2008/1293; H01M 8/1233; H01M 8/0612

(57) ABSTRACT

A flame-assisted fuel cell gas turbine hybrid system including a first combustor, a second combustor, and a flame-assisted solid oxide fuel cell configured to receive syngas from the first combustor, react the syngas with oxygen ions to yield carbon dioxide and water, and provide unreacted syngas to the second combustor. The first combustor is configured to receive heated compressed air from an aircraft engine compressor and the second combustor is configured to provide heated air to an aircraft engine gas turbine to generate mechanical power.

### CROSS-REFERENCE TO RELATED APPLICATION

This application claims the benefit of U.S. Patent Application No. 62/823,302 entitled “SOLID OXIDE FUEL CELL PLACEMENT IN GAS TURBINE COMBUSTOR” and filed on Mar. 25, 2019, which is incorporated herein by reference.

### TECHNICAL FIELD

This invention relates to a solid oxide fuel cell for placement in a gas turbine combustor.

### BACKGROUND

Over the past few decades, the aircraft industry has been pushing for the concept of More Electric Aircraft (MEA) which aims at replacing the pneumatic and hydraulic systems in the aircraft with their electrical counterparts. This replacement has the advantage of added flexibility, ease of use and higher efficiency compared to the mechanical systems. This, along with the greater push towards leaner and cleaner air travel has led to an increase in the search for more efficient technologies. Several attempts have been made both successfully and unsuccessfully to replace various systems in the aircraft with their electrical counterparts. One such system is the Auxiliary Power Unit (APU), a gas turbine responsible for various functions like cabin cooling and lighting, starting the main engines, and providing power for aircraft controls. The traditional APU systems have very low efficiencies of at best 40% at cruising altitudes and 20% at sea level. In addition, these aircraft APUs are a major source of pollutants like NOₓ, which is especially dangerous due to its tendency to cause acid rain.

### SUMMARY

In a first aspect, a flame-assisted fuel cell gas turbine hybrid system includes a first combustor, a second combustor, and a flame-assisted solid oxide fuel cell configured to receive syngas from the first combustor, react the syngas with oxygen ions to yield carbon dioxide and water, and provide unreacted syngas to the second combustor. The first combustor is configured to receive heated compressed air from an aircraft engine compressor and the second combustor is configured to provide heated air to an aircraft engine gas turbine to generate mechanical power. Implementations of the first aspect may include one or more of the following features.

The flame-assisted fuel cell typically has a tubular configuration. The system may include an aircraft engine compressor, an aircraft engine gas turbine, or both. The first combustor is typically configured to combust jet fuel. The system may include a heat exchanger configured to provide cooling air to the first combustor, the second combustor, and the flame-assisted fuel cell. The system may include a recuperator configured to heat the compressed air from the airplane engine compressor to yield the heated compressed air. The recuperator is configured to heat the compressed air from the airplane engine compressor with exhaust from the aircraft engine turbine. The system may be configured to convert jet fuel to electricity and to heat. The system is free of a reformer.

In a second aspect, generating electricity and heat from jet fuel includes providing jet fuel and compressed air from an aircraft engine compressor to a first combustor, combusting the jet fuel in the first combustor to yield syngas, reacting the syngas in a flame-assisted solid oxide fuel cell to generate electricity and yield carbon dioxide and water, and providing unreacted syngas from the first combustor to a second combustor to generate heat. Implementations of the second general aspect may include one or more of the following features.

The heat from the second combustor may be provided to an aircraft engine turbine. Exhaust from the aircraft engine turbine may provided to a recuperator. The compressed air from the aircraft engine compress may be heated with the exhaust from the aircraft engine turbine. The jet fuel is in a stoichiometric excess relative to oxygen in the first combustor. The unreacted syngas is in a stoichiometric deficit relative to oxygen in the second combustor. Heat addition to the system occurs in the first combustor, the flame-assisted solid oxide fuel cell, and the second combustor. Some implementations include cooling the first combustor, the flame-assisted solid oxide fuel cell, and the second combustor with air from the aircraft engine compressor. Some implementations include providing the heat to the aircraft engine gas turbine. Generating the electricity and the heat from the jet fuel is achieved in the absence of a fuel reformer.

Advantages include direct conversion of a part of the incoming jet fuel to electricity while the rest is converted to heat used to run the gas turbine, and operation in the absence of a reformer, thereby allowing a reduction in system weight when compared to the power output of the fuel cell.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF THE DRAWINGS

FIG. 1 is a schematic of a gas turbine cycle with recuperation.

FIG. 2 is a schematic of a flame-assisted fuel cell (FFC) with combustion zones and reactions.

FIG. 3 is a schematic of a dual chamber solid oxide fuel cell (DC-SOFC) integrated gas turbine hybrid system.

FIG. 4 is a schematic of a FFC gas turbine hybrid system.

FIG. 5 is a schematic of an experimental FCC gas turbine hybrid system.

FIG. 6 is a schematic of a supercritical CO₂ (sCO₂) gas turbine cycle with recuperation and recompression showing the various state points in the system.

FIG. 7 is a schematic of a FFC with combustion zones and reactions.

FIG. 8 is a schematic of an FFC sCO₂ gas turbine hybrid system.

FIG. 9 is a schematic of an experimental FFC sCO₂ gas turbine hybrid system.

### DETAILED DESCRIPTION

In a first general aspect, this disclosure describes a flame-assisted fuel cell (FCC) gas turbine hybrid system for an aircraft engine

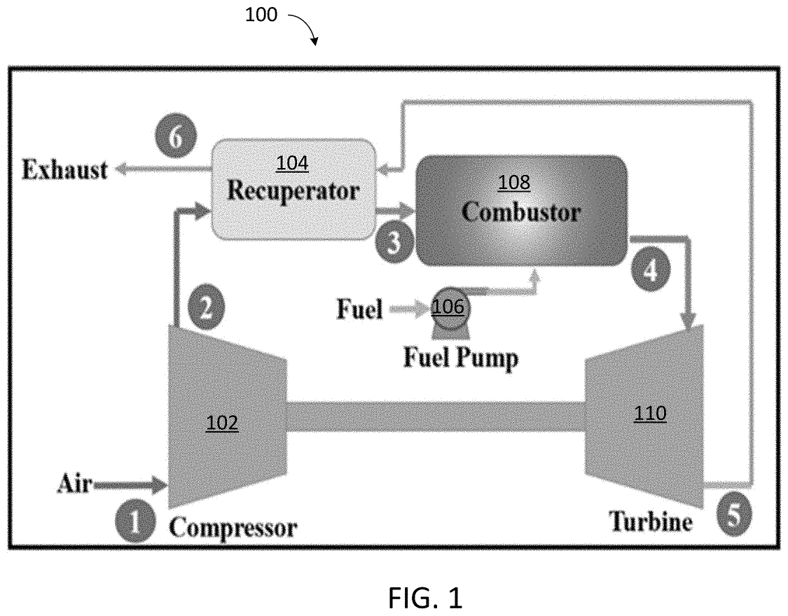

Gas Turbine Cycle. FIG. 1 depicts system 100 including a gas turbine cycle with recuperation. Air is taken from environment at State 1 and compressed by compressor 102 to State 2. The compressed air is preheated in the recuperator 104 by the turbine exhaust and reaches State 3. Fuel is provided by fuel pump 106 to combustor 108. The preheated air is further heated in combustor 108 and reaches State 4. Turbine 110 then generates mechanical power in the turbine and reaches State 5. Exhaust from turbine 110 transfers heat to the incoming air in the recuperator 104, then leaves the system as exhaust to the environment in State 6. The efficiency of this system (η_{GT}) is given in Eq. 1. In Eq. 1, H₁, H₂, H₄, H₅ are the total enthalpies of States 1, 2, 4 and 5, respectively. \dot{n}_{f} is the molar flow rate of fuel and HHV_{f} is the mole specific higher heating value of fuel. Fuel pump work is assumed to be negligible.

$${η}_{G T} = \frac{( {H}_{4} - {H}_{5} ) - ( {H}_{2} - {H}_{1} )}{{\dot{n}}_{f} \cdot {HHV}_{f}} \qquad Eq . 1$$

Flame-assisted Fuel Cells. For this analysis, calculations in all the subsequent sections are done at a specific equivalence ratio. Equivalence ratio (Φ) is defined as shown in Eq.2. In Eq.2, n_{fuel} and nₐᵢᵣ represent molar flow rates of fuel and air, respectively. The superscript capital S in the molar flow rate terms in the denominator represent the molar flow rates required for stoichiometric reaction. Thus, when Φ>1, it represents fuel-rich combustion, when φ<1, it represents fuel-lean combustion and when Φ=1, it represents stoichiometric combustion.

$$Φ = \frac{\frac{{n}_{f u e l}}{{n}_{a i r}}}{\frac{{n}_{f u e l}^{s}}{{n}_{a i r}^{s}}} \qquad Eq . 2$$

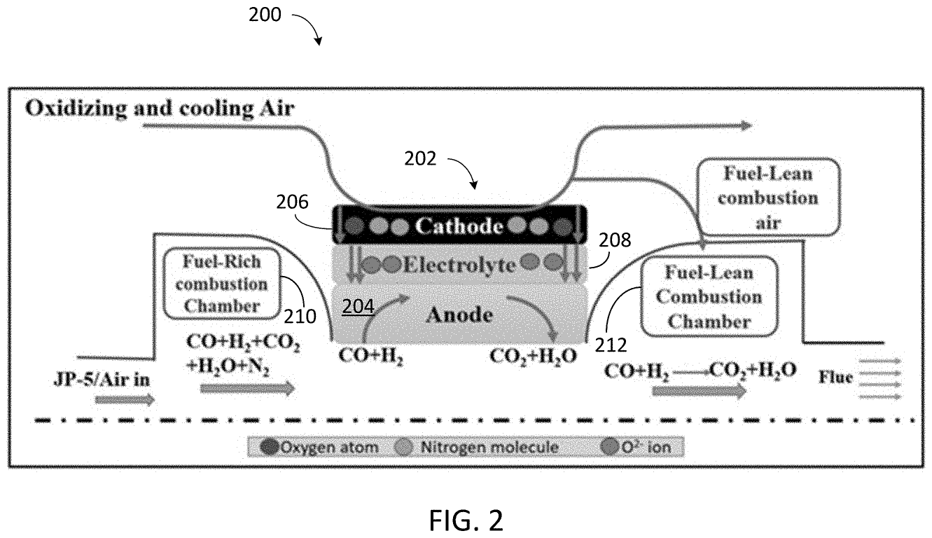

FIG. 2 depicts system 200 including FFC 202 with various reaction zones. FFC 202 includes porous anode 204 and cathode 206 separated by a dense electrolyte 208. Anode 204 and cathode 206 have high ionic and electronic conductivity, whereas electrolyte 208 has high ionic conductivity. The fuel/air mixture sent to fuel-rich combustion chamber 210 is partially oxidized generating syngas (i.e., H₂ and CO) and products of combustion. The syngas then diffuses into anode 204 where it reacts with the oxygen ion coming from the cathode side through electrolyte 208 to form carbon dioxide and water. After FFC 202, the syngas that remains unreacted is then combusted with excess air in fuel-lean combustion chamber 212 to generate heat. The exhaust of fuel-lean combustion chamber 212 is discharged from system 200.

Steps in FIG. 2 are described in greater detail below. The first reaction is the fuel-rich combustion of JP-5 (simplified as C₁₂H₂₃) in air. This reaction is shown in Eq.3. In Eq.3, φ is the equivalence ratio of the fuel-rich combustion reaction. The coefficients of the products of fuel-rich combustion are calculated using chemical equilibrium where the element balance follows as shown below in Eq.4, Eq.5, Eq.6 and Eq.7.

ΦC₁₂H₂₃+18.25(O₂+3.76N₂)→aCO+bH₂+cCO₂+dH₂O+eN₂ Eq.3

C: a+c=12Φ Eq.4

H: 2b+2d=23Φ Eq.5

O: a+2c+d=36.5 Eq.6

N: e=68.62 Eq.7

The enthalpy released by the fuel-rich combustion reaction (ΔH_{RC}) can be calculated as shown in Eq.8, where \dot{n} is the molar flow rate and h_{f} is the molar enthalpy of formation of the respective species.

$$Δ {H}_{RC} = {\dot{n}}_{CO} {h}_{CO , 1073 K} + {\dot{n}}_{{CO}_{2}} {h}_{{CO}_{2} , 1073 K} + {\dot{n}}_{{H}_{2} O} {h}_{{H}_{2} O , 1073 K} + {\dot{n}}_{{H}_{2}} {h}_{{H}_{2} , 1073 K} + {\dot{n}}_{{N}_{2}} {h}_{{N}_{2} , 1073 K} - {\dot{n}}_{{C}_{12} {H}_{23}} {h}_{{f}_{{C}_{12} {H}_{23} , 1073 K}} - {\dot{n}}_{{O}_{2}} {h}_{{O}_{2} , 850 K} - {\dot{n}}_{{N}_{2}} {h}_{{N}_{2} , 1073 K} \qquad Eq . 8$$

The exhaust from the fuel-rich combustion, as shown in Eq.3, passes through the fuel cell to generate heat and electrical power. The fuel cell cannot convert all of the incoming fuel energy into electrical power due to various losses in the fuel cell. This gives rise to various efficiencies in the fuel cells, most important of which are the fuel utilization efficiency (η_{fu}), the fuel cell conversion efficiency (η_{fc}) and the overall efficiency (ηₒᵥ) as described below in Eq.9, Eq.10 and Eq.11 respectively.

$$\begin{matrix}{η}_{fu} = \frac{Syngas electrochemically oxidized in FFC}{Total Syngas available in exhaust} & Eq . 9 \\ {η}_{fc} = \frac{Electrical Power generated by FFC}{Total Chemical energy of the syngas utilized} & Eq . 10 \\ {η}_{ov} = \frac{Electrical power generated by fuel cell}{Chemical energy from the hydrocarbon fuel} & Eq . 11\end{matrix}$$

Both CO and H₂ from the fuel-rich combustion products are used as fuel in the FFC for electrochemical oxidation generating electrical power. The fuel cell reactions are shown in Eq.12 and Eq.13.

H₂+O²⁻→H₂O+2e⁻ Eq.12

CO+O²⁻→CO₂+2e⁻ Eq.13

The resulting overall reaction of the fuel cell can be shown as follows in Eq.14.

a₁CO+b₁H₂+cCO₂+dH₂O+eN₂+γ₁(O₂+3.76N₂)→(a₁+c)CO₂+(b₁+d)H₂O+(3.76γ₁+e)N₂ Eq.14

The coefficients a₁, b₁, c, d, e and γ₁ depend upon the coefficients a, b, c, d, e, γ from Eq.3 and the fuel utilization efficiency.

Considering only the species taking part in the fuel cell reaction, Eq.14 reduces as shown in Eq.15.

a₁CO+b₁H₂+γ₁O₂→a₁CO₂+b₁H₂O Eq.15

For one mole of syngas, Eq.15 reduces to the one shown in Eq.16.

$$\frac{{a}_{1}}{{a}_{1} + {b}_{1}} CO + \frac{{b}_{1}}{{a}_{1} + {b}_{1}} {H}_{2} + \frac{{γ}_{1}}{{a}_{1} + {b}_{1}} {O}_{2} \to \frac{{a}_{1}}{{a}_{1} + {b}_{1}} {CO}_{2} + \frac{{b}_{1}}{{a}_{1} + {b}_{1}} {H}_{2} O \qquad Eq . 16$$

The mole specific enthalpy change of reactions in Eq.15 (Δh_{FC}) is used to calculate the thermal neutral potential (Vₜₕ). Vᵣₑᵥ is the reversible potential of the fuel cell. This is calculated using the standard state mole specific Gibbs' free energy released by reaction in Eq.15 (Δg°_{FC}) and the Nernst equation as shown in Eq.18. Vₜₕ and Vᵣₑᵥ are calculated as shown in Eq.17 and Eq.18, respectively. In Eq.17 and Eq.18 n is the number of moles of electrons released in the fuel cell reaction per mole of fuel (2 for one mole of syngas) and F is Faraday's constant, T is the temperature (1073 K) and K is the equilibrium constant of the reaction in Eq.15.

$$\begin{matrix}{V}_{th} = \frac{- Δ {h}_{F C}}{n F} & Eq . 17 \\ {V}_{r e v} = \frac{- Δ g {°}_{FC}}{n F} - \frac{R T}{n F} ln ( K ) & Eq . 18\end{matrix}$$

The equilibrium constant shown in Eq.18 can be calculated as shown in Eq.19 where Pᵢ/P is the ratio of partial pressures of species i and vᵢ/v_{syn} are the coefficients of species i in Eq.16. The ratio of partial pressures in the system is taken equal to the mole fraction of the corresponding species assuming ideal gas behavior.

$$K = {\prod }_{i = 1}^{N} {( \frac{{P}_{i}}{P} )}^{\frac{{v}_{i}}{{v}_{s y n}}} \qquad Eq . 19$$

For the fuel cell reaction, the rate constant can be calculated as shown in Eq.20. Since CO₂ and H₂O are assumed not to take part in the reaction, they have no effect on the equilibrium constant.

$$K = {X}_{{H}_{2}}^{( \frac{- b}{a + b} )} {X}_{{O}_{2}}^{( \frac{- γ}{a + b} )} {X}_{CO}^{( \frac{- a}{a + b} )} \qquad Eq . 20$$

Exhaust compositions of the fuel-rich combustion of JP-5 are required to calculate the Vᵣₑᵥ.

Table 1 shows the simulated exhaust compositions obtained from NASA CEA for JP-5 in air at different equivalence ratios at 1073 K. Chemical equilibrium is a good approximation for estimating the combustion exhaust for different hydrocarbon fuels in FFC studies. This technique minimizes the Gibbs' free energy and gives the mole fractions of the products at equilibrium. NASA CEA has been used in this case to solve the chemical equilibrium analysis. This composition is used to calculate the theoretical Vᵣₑᵥ of the fuel cell.

TABLE 1
NASA CEA exhaust composition of JP-5 in
air for different equivalence ratios

| Equivalence ratio | CO | H₂ | CO₂ | N₂ |
|---|---|---|---|---|
| 1.20 | 0.074 | 0.017 | 0.074 | 0.798 |
| 1.40 | 0.11 | 0.035 | 0.057 | 0.774 |
| 1.60 | 0.141 | 0.060 | 0.041 | 0.739 |
| 1.80 | 0.167 | 0.090 | 0.030 | 0.698 |
| 2.00 | 0.188 | 0.121 | 0.022 | 0.657 |
| 2.20 | 0.206 | 0.151 | 0.016 | 0.617 |
| 2.40 | 0.222 | 0.18 | 0.011 | 0.579 |
| 2.60 | 0.237 | 0.206 | 0.007 | 0.542 |
| 2.80 | 0.25 | 0.231 | 0.003 | 0.509 |

Table 2 shows theoretically calculated reversible cell potential (Vᵣₑᵥ) of the fuel cell for the exhaust compositions obtained from NASA CEA for JP-5 in air at 1073 K. It can be seen that as equivalence ratio increases, the theoretical Vᵣₑᵥ increases. This is because the concentration of fuel (CO+H₂) in the exhaust increases when the equivalence ratio increases leading to lower Nernstian losses.

TABLE 2
Theoretical Vᵣₑᵥ for the dry combustion exhaust composition at
various equivalence ratios at 1073K

| | Eq. Ratio | | | | | | | | |
|---|---|---|---|---|---|---|---|---|---|
| | 1.2 | 1.4 | 1.6 | 1.8 | 2.0 | 2.2 | 2.4 | 2.6 | 2.8 |
| Vᵣₑᵥ | 0.946 | 0.983 | 1.001 | 1.011 | 1.018 | 1.022 | 1.026 | 1.029 | 1.031 |

The power generated by the fuel cell (P_{fc}) is shown in Eq.21. In Eq.21, η_{fu} is the fuel utilization efficiency, η_{fc} is the fuel cell efficiency and Δg_{FC} is the mole specific Gibbs' free energy released by the fuel cell reaction in Eq.15.

P_{fc}=n_{C}_{₁₂}_{H}_{₂₃}η_{fu}·η_{fc}·Δg_{FC} E_{q}.21

The total heat released by the fuel cell reactions is shown in Eq.22. In Eq.22, ΔH_{FC} is the total enthalpy released by the fuel cell reactions in Eq.15.

H_{fc}=−η_{fu}·(1−η_{fc})·ΔH_{FC} Eq.22

After the fuel cell, the remaining fuel passes into the fuel-lean combustion chamber to generate thermal energy which provides heat for the turbine inlet. The fuel-lean combustion reaction is shown in Eq.23. In Eq.23, The coefficients a₂, b₂, c₂, d₂, e₂ and γ₂ depend upon the coefficients a, b, c, d, e, γ from Eq.3 and the fuel utilization efficiency such that if a moles of CO and b moles of H₂ are produced in fuel-rich combustion and a₁ and b₁ moles of CO and H₂ respectively react in the fuel cell reaction, then a₂ equals the difference between a and a₁ and b₂ equals the difference between b and b₁. Whereas, c₂, d₂ and e₂ are the sum of c and a₁, d and b₁ and e and 3.76γ₁ respectively from Eq.14 since those are species assumed to not take part in the fuel cell reaction. γ₂ is based upon the equivalence ratio of the fuel-lean combustion.

a₂CO+b₂H₂+c₂CO₂+d₂H₂O+e₂N₂+γ₂(O₂+3.76N₂)→(a₂+c₂)CO₂+(b₂+d₂)H₂O+(3.76γ₂+e₂)N₂ Eq.23

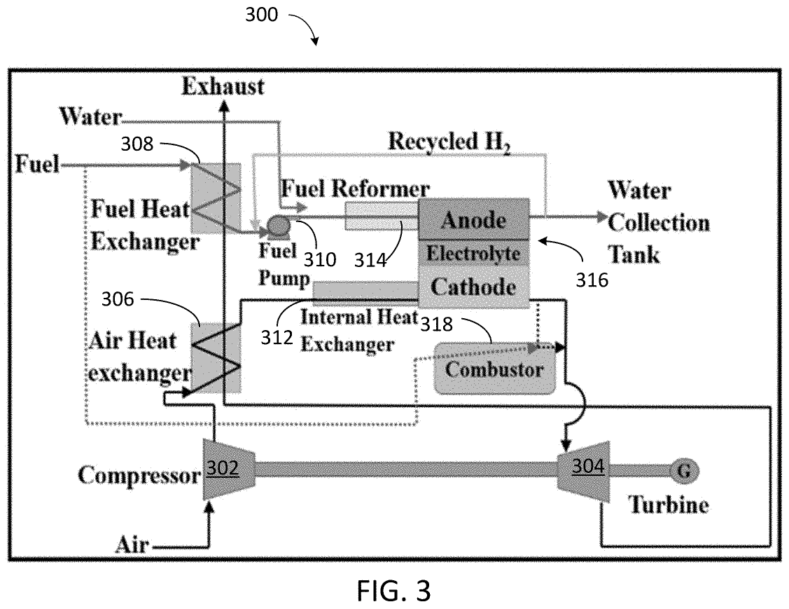

FFC-Gas turbine hybrid. FIG. 3 depicts dual chamber solid oxide fuel cell (DC-SOFC) integrated gas turbine hybrid system 300. DC-SOFC gas turbine hybrid system 300 includes compressor 302, turbine 304, air heat exchanger 306, fuel heat exchanger 308, fuel pump 310, internal heat exchanger 312, fuel reformer 314, FCC 316, and combustor 318.

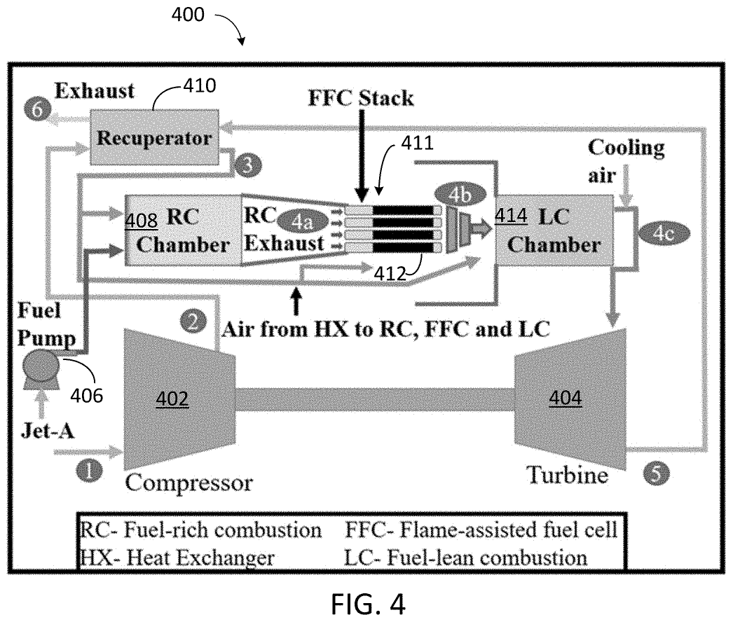

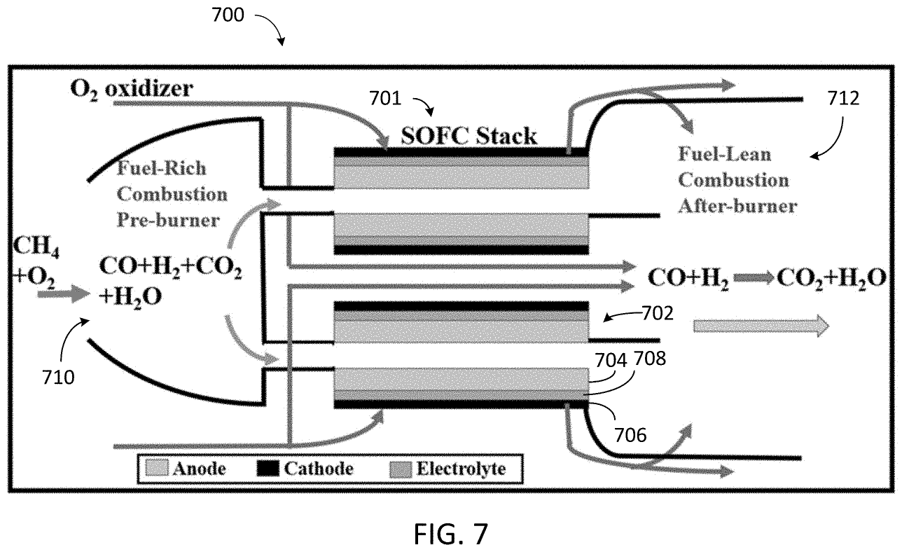

FIG. 4 depicts FFC gas turbine hybrid system 400. States 1-6 correspond to those described with respect to FIG. 1, with States 4a-4c in FIG. 4 replacing single State 4 in FIG. 1. FCC gas turbine hybrid system 400 includes compressor 402, turbine 404, fuel pump 406, fuel-rich combustor 408, recuperator 410, FFC stack 411 including two or more FFCs 412, and fuel-lean combustor 414. Here, “fuel-rich” generally means a stoichiometric excess of fuel compared to oxidant (e.g., oxygen). FFCs 412 are typically in a tubular configuration, as depicted in cross section in FIG. 7. “Fuel-lean” generally means a stoichiometric excess of oxidant (e.g., oxygen) relative to fuel. Compressor 402 and turbine 404 are components of an aircraft engine, and jet fuel (e.g., JP-5) is used to heat the air and generate power with the turbine to power compressor 402 and fuel pump 406. Air from heat exchanger 416 is provided to fuel-rich combustor 408, FFC stack 411, and fuel-lean combustor 414. Exhaust from fuel-rich combustor 408 is provided to FFC 411, and the output from FFC stack 411 is provided to fuel-lean combustor 414. Heat addition in system 400 takes place in States 4a-4c. A stream of cooling air is taken from an outlet of compressor 402 and passed, through recuperator 410, over fuel-rich combustor 408, FFC stack 411, and fuel-lean combustor 414 to reduce overheating components of system 400 (e.g., the current collector). This cooling air progressively heats up and is provided, as exhaust of fuel-lean combustor 414, to turbine 404. Output from turbine 404 is provided to recuperator 410 and exits system 400 as exhaust. Thus, FCC gas turbine hybrid system 400 allows a part of the incoming jet fuel to be converted directly to electricity while the rest is converted to heat which is used to run the gas turbine.

Comparing systems 300 and 400 reveals the simplicity of FCC gas turbine hybrid system 400 compared to DC-SOFC integrated gas turbine hybrid system 300. Various heat exchangers in system 300 are absent in system 400. Moreover, system 400 is free of a fuel reformer, thereby further reducing the complexity and the weight of the system. System 400 is also free of a separate combustor (e.g., combustor 318) for adding heat to the fuel cell exhaust for turbine power generation.

The efficiency of the FFC gas turbine hybrid cycle (η_{hyb}) shown in FIG. 4 is calculated as shown in Eq. 24. In Eq. 24, H_{4c}, H₅, H₂, H₁ are the total enthalpies of States 4c, 5, 2 and 1, respectively whereas P_{fc} is the power generated by the fuel cell and \dot{n}_{f} is the molar flow rate of fuel and HHV_{f} is the molar higher heating value of JP-5. Fuel pump work is assumed to be negligible.

$${η}_{hyb} = \frac{( {H}_{4 c} - {H}_{5} ) - ( {H}_{2} - {H}_{1} ) + {P}_{fc}}{{\dot{n}}_{f} \cdot {HHV}_{f}} \qquad Eq . 24$$

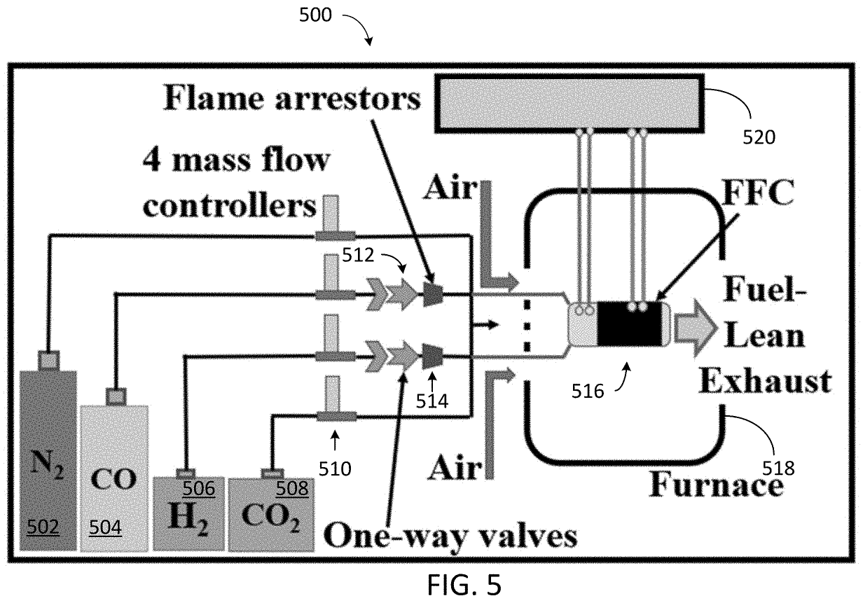

Experimental. FIG. 5 shows a schematic of experimental system 500 designed to test the performance of a fuel cell with model exhaust. The experiment was done with a model dry exhaust, i.e., nitrogen 502, carbon monoxide 504, hydrogen 506, and carbon dioxide 508, where the composition of the exhaust was based on chemical equilibrium calculations. Mass flow controllers 510 were used to regulate the flow of these gases. One-way valves 512 are operatively positioned between mass controllers 510 and flame arrestors 514 placed in the CO and H₂ lines in order to avoid flashback.

The flow rates of these gases were calculated using the NASA CEA exhaust compositions for a constant inlet flow rate of 0.1255 mg·s⁻¹. The volumetric flow rate of species ‘i’ (V₁) was calculated using Eq. 25 at each equivalence ratio in units of mL·min⁻¹. In Eq. 25, Xᵢ is the mole fraction of species ‘i’ obtained from Table 1 at corresponding equivalence ratio. X_{CO} and X_{CO2} are the mole fractions of CO and CO₂ respectively at corresponding equivalence ratio and Vₘₒₗ is the molar volume of ideal gas at 298 K, 1 Bar pressure. To obtain the individual gas flow rates, a total flow rate of JP-5 was fixed, and the total exhaust flow rate was multiplied by the individual species mole fractions obtained from NASA CEA as shown in Table 1. The corresponding flow rates of each component of the dry exhaust at various equivalence ratios is given in Table 3. The gases were all mixed and sent to FFC 516 inside furnace 518 at 1073 K. The anode and cathode of FFC 516 were connected to source meter 520 using current collectors in order to measure the data. The current-voltage method with 4 probe technique was used to obtain the results. In a 4 probe method, a high impedance current source is used to supply current through the outer two probes; a voltmeter measures the voltage across the inner two probes to determine the power density. Air for cathode was directly taken from the environment, as shown in FIG. 5.

$${V}_{i} = \frac{{\dot{n}}_{f}}{( \frac{{X}_{CO} + {X}_{{CO}_{2}}}{12} )} * {X}_{i} * 60 * {V}_{m o l} \qquad Eq . 25$$

TABLE 3
Flow rates of gases used in the experiment

| | CO | H₂ | CO₂ | N₂ | Total |
|---|---|---|---|---|---|
| Equivalence | (ml · | (ml · | (ml · | (ml · | (ml · |
| ratio | min⁻¹) | min⁻¹) | min⁻¹) | min⁻¹) | min⁻¹) |
| 1.20 | 6.49 | 1.55 | 6.48 | 69.48 | 84 |
| 1.40 | 8.48 | 2.70 | 4.42 | 59.72 | 75.32 |
| 1.60 | 9.87 | 4.23 | 2.91 | 51.75 | 68.76 |
| 1.80 | 10.77 | 5.82 | 1.94 | 45.09 | 63.62 |
| 2.00 | 11.34 | 7.30 | 1.33 | 39.69 | 59.66 |
| 2.20 | 11.74 | 8.60 | 0.92 | 35.21 | 56.47 |
| 2.40 | 12.02 | 9.75 | 0.61 | 31.38 | 53.76 |
| 2.60 | 12.29 | 10.68 | 0.36 | 28.15 | 51.48 |
| 2.80 | 12.50 | 11.55 | 0.16 | 25.47 | 49.68 |

Fuel cell fabrication. The FFC anode (NiO+YSZ, (Y₂O₃)_{0.08}(ZrO₂)_{0.92}) and electrolyte (YSZ, ˜22 μm thick) were prepared as described in Int. J. Hydrogen Energy 41 (2016) 20670-20679, which is incorporated by reference herein. The anode was pre-fired at 1373 K. The electrolyte was dip coated on the anode. The final internal diameter of the tubular FFC was 2.2 mm and the outer diameter was 3.3 mm. A buffer layer of Sm_{0.20}Ce_{0.80}O_{2-X} (SDC) was spray deposited onto the (YSZ) electrolyte. It was then dried and sintered at 1673 K for 4 h. An SDC+LSCF (La_{0.60}Sr_{0.40})_{0.95}Co_{0.20}Fe_{0.80}O₃₋ₓ) cathode was dip coated onto the buffer layer which was later dried and sintered at 1373 K for 2 hours. Silver wire and silver paste were used as current collector on the cathode and anode. The total active area of the cell is 4.32 cm².

Fuel cell performance. The performance of the FFC operating at 1073 K with a model fuel-rich combustion exhaust composition between equivalence ratios of 1.2 to 2.8 was evaluated. Significant power densities were achieved at all equivalence ratios. It was found that as equivalence ratio increases, the OCV increases. Also, as the equivalence ratio changes, the slope of the voltage curve at smaller current densities remains the same. This occurs since at these current densities, ohmic loss dominates and since the resistance of the materials doesn't depend significantly on the equivalence ratio, this loss is constant. At larger current densities, the voltage decays at a faster rate as equivalence ratio decreases. This happens because as the equivalence ratio decreases, the concentration of syngas in the fuel-rich combustion exhaust decreases. This leads to higher concentration losses at lower equivalence ratios leading to the rapid decay. The activation loss was consistently negligible across all equivalence ratios. The maximum power density of the fuel cell increases with increase in equivalence ratios. As the equivalence ratio increases, higher concentration of syngas in the fuel-rich combustion exhaust leads to larger Gibbs' energy released in the fuel cell leading to higher total power being generated. At an operating voltage of 0.7 V, the maximum power density of the fuel cell was 259 mW·cm⁻² at an equivalence ratio of 2.8.

Fuel utilization efficiency was calculated as explained earlier in Eq.9. For fuel utilizations at various voltages, fuel utilization of close to 90% was achieved at 0.1 V, which was the lower voltage limit set for the experiment. This high fuel utilization result will help overcome an obstacle for FFCs, i.e., low fuel utilization efficiencies leading to low overall efficiencies, which improve practical implementation. At standard operating voltage points of 0.5 V, close to 75% fuel utilization efficiency was achieved.

The Vᵣₑᵥ obtained theoretically as shown in Table 2 matches the experimentally obtained OCV. The analytical calculations consider Nernstian losses for the calculation of Vᵣₑᵥ. The increase is rapid initially at low equivalence ratios, but slows down as equivalence ratio increases. As equivalence ratio increases, the concentration of syngas in the fuel-rich combustion exhaust increases rapidly initially, but the rate of increase slows down at higher equivalence ratios. As the concentration of fuel increases in the exhaust, the Nernstian losses decrease leading to increase in the OCV. The small difference in the experimental and theoretical values are primarily due to small temperature fluctuations and leakages in the fuel cell.

Gas turbine performance with and without the fuel cell at sea level. The computation for gas turbine calculations with and without the fuel cell is done using the assumption that the fuel cell will perform in the same way as it did in the experimental results when scaled for the design power. The gas turbine cycle is analyzed for a total JP-5 flow rate of 3 g·s⁻¹ (total input chemical energy of 122.083 kW) and a preheat temperature of 850 K. At sea level, the inlet pressure of air is 1 bar and pressure after the compression cycle is 8 bar. The temperature of the inlet air is assumed to be 298 K. The fuel-rich equivalence ratio is varied, but the fuel-lean equivalence ratio is kept constant at 0.8. The isentropic efficiency of the turbine is assumed to be 85% and that of compressor is assumed to be 90%. The recuperator was assumed to be 90% efficient. η_{FU} and η_{FC} are taken directly from experimental results. The power generated by the various parts of the system with and without the FFC integrated at sea was assessed. As equivalence ratio increases, the power generated by the gas turbine part of the FFC gas turbine hybrid system decreases. This may be primarily because as the equivalence ratio increases, more and more power is generated by the FFC part of the system and less enthalpy is available for the gas turbine for power generation. The part of the FFC gas turbine hybrid cycle power generated by FFC increases since at higher equivalence ratios more syngas is available leading to higher total power generated. The maximum power generated by the FFC gas turbine hybrid cycle is 72.82 kW at an equivalence ratio of 2.8. Thermodynamic analysis was performed on the entire cycle and to verify that the total chemical energy of the fuel going into the system was equal to the sum of total power generated by the system when corrected to system efficiencies and the total heat rejected in the exhaust, thus conserving the total energy.

The efficiency of the cycle with and without the fuel cell integrated at sea level was assessed. As equivalence ratio increases, the overall efficiency of the cycle increases. This is believed to be because as equivalence ratio increases, the power generated by the fuel cell in the FFC gas turbine hybrid system increases much faster than the decrease in the gas turbine power. This is because fuel cell generates power at a higher efficiency than the gas turbine. This leads to overall increase in efficiency. Without the fuel cell integrated, there is no change in the efficiency of the system with equivalence ratio since the standard gas turbine cycle operates at a single fuel-lean equivalence ratio of 0.8. It shows that at equivalence ratio of 2.8, the efficiency change is 29.8% increase over the base value without the fuel cell.

Gas turbine performance with and without the fuel cell at cruising altitudes. The APU gas turbine sees different conditions at ground level and at cruising altitude of 10668 m. The pressure of air at that altitude is 0.29 bar and the temperature is 219 K. As a result, it is important to consider the performance of the FFC gas turbine hybrid system at cruising altitudes. The power generated by various parts of the system with and without the FFC integrated at cruising altitudes was assessed. Since the efficiency of the cycle increases at cruising altitudes the total power generated is higher at cruising altitudes for the same amount of fuel flow rate. A reason for this change is the increase in power generated by the gas turbine cycle. The power generated by the FFC stack remains substantially the same. It can be seen that at cruising altitudes, a gas turbine without fuel cell generates 33% more power on its own leading to this increase in the total power produced. Similar to sea level, the part of the power produced by gas turbine in the FFC gas turbine hybrid system decreases with increase in equivalence ratio and the FFC power increases with increase in equivalence ratio though the total power produced by the FFC gas turbine hybrid system increases. The maximum power generated by the FFC gas turbine hybrid cycle is 85.96 kW.

The efficiency of the cycle with and without the fuel cell integrated at sea level was assessed. The gas turbine was more efficient at cruising altitudes than at sea level. This is at least because the pressure ratio of the gas turbine cycle is 27.58 instead of the 8 at sea level. The increase in pressure ratio leads to an increase in the amount of work that can be extracted from the working fluid. On the other hand, the fuel cell performance is same as at ground level since the fuel cell does not see any change in pressure as it only comes up in the cycle after compression and before the turbine. Similar to the sea level result, the gas turbine cycle efficiency doesn't change with equivalence ratio whereas the overall efficiency of the FFC gas turbine hybrid system increases as the equivalence ratio increases.

Analysis of the thermodynamic cycle. To understand how the thermodynamic properties change when adding the FFC to the gas turbine cycle, the Temperature-Entropy (T-s) diagram and the Pressure-Volume (P-v) diagram of the cycle can be analyzed. A comparison of the standard gas turbine cycle is made with the FFC gas turbine hybrid cycle at equivalence ratios of 2 and 2.8. As equivalence ratio increases, less enthalpy is released in the fuel-rich combustion since more partial oxidation is favored over complete oxidation. The process from States 4a to 4c represents the enthalpy added in the FFC. It can be seen that as equivalence ratio increases, enthalpy added in the FFC increases since more fuel is available in the fuel-rich combustion exhaust for heat generation in the fuel cell. Since the electric power generated in the FFC is not mechanical, it is not represented in the P-v or T-s diagram, but the heat generated is represented. The apparent power generated by the gas turbine in the cycle is lower at higher equivalence ratios. This is mainly due to the absence of FFC electrical power in the cycle and that air is introduced in the system in different states, as shown in FIG. 4. Due to the air added in the fuel-lean combustion chamber after the FFC the specific entropy and the specific volume decreases between 4b and 4c. The power generated by the gas turbine in the FFC gas turbine hybrid cycle decreases as equivalence ratio increases which supports the earlier conclusions. As equivalence ratio increases the exhaust temperature decreases. This happens because at higher equivalence ratios, more energy is converted to electric power in the FFC leading to lower exit enthalpy and temperature.

Breakeven distance. Breakeven distance of an aircraft (D_{br}) is defined as the distance the aircraft has to travel in order to make up for the added weight of the FFC system. After this breakeven distance, the FFC integrated aircraft APU will be more fuel efficient than its standard gas turbine counterparts. This is possible because adding the FFC has been shown in the earlier sections to increase the efficiency of the base system. The reported mileage of a common commercial passenger is 11.11 kg·km⁻¹. The breakeven distance of the aircraft can be calculated as shown in Eq. 26. In Eq. 26, Pfc is the power generated by the fuel cell stack. W_{fc} is the area specific weight of the fuel cell stack which is assumed to be 0.8 g·cm⁻². The area specific weight of the fuel cell only in the stack was measured to be 0.6 g·cm⁻². PD_{fc} is the power density of the fuel cell stack which is taken as the operating power density of the fuel cell from experimental results at an equivalence ratio of 2.8, i.e., 250 mW·cm⁻². As the power generated by the fuel cell stack increases (and therefore the weight), the breakeven distance of the aircraft increases linearly. The system generates 86 kW at its maximum efficiency, so the breakeven distance for an aircraft using this system will be 80 km. Even with just a fraction of one trip of aircraft, which has a range of 11,000 km, the system will break even with fuel efficiency and will have higher fuel efficiency for the rest of the system life.

$${D}_{b r} = \frac{{P}_{fc} {W}_{fc}}{P {D}_{fc} ( \frac{{η}_{hyb}}{{η}_{G T}} M i {l}_{747} - M i {l}_{747} )} \qquad Eq . 26$$

In summary, in this first general aspect, a theoretical model of a FFC gas turbine hybrid system was developed. Analysis of the efficiency of the FFC gas turbine hybrid system has shown a 30.85% increase at sea level and a 16.27% increase over the efficiency of the standard gas turbine cycle. A FFC is tested with model fuel-rich combustion exhaust at equivalence ratios of 1.2 to 2.8. The theoretically predicted reversible voltages show good agreement with the experimental values of open circuit voltage. High fuel utilization efficiencies were achieved. A power density of 259 mW·cm⁻² at a voltage of 0.7 V was observed in the experiment of the fuel cell at an equivalence ratio of 2.8. The FFC achieved a 75% fuel utilization at 0.5 V. The FFC gas turbine hybrid system has potential of being up to 58% efficient at sea level and 70% efficient at cruising altitudes at a fuel-rich equivalence ratio of 2.8. The portion of the total power in the FFC gas turbine hybrid system generated by FFC alone increases with increase in equivalence ratio whereas the gas turbine part of the total power decreases with increase in equivalence ratio. The total power of the FFC gas turbine hybrid system is higher at all equivalence ratios from 1.2 to 2.8 and increases with increase in equivalence ratio.

In a second general aspect, this disclosure describes a supercritical CO₂ (sCO₂) gas turbine cycle.

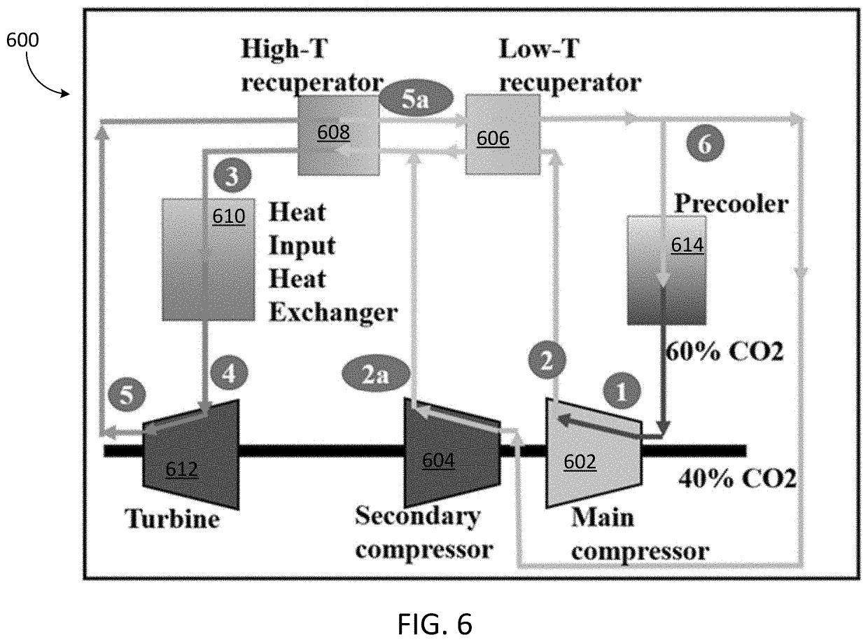

sCO₂ gas turbine cycle. This section describes the theory of a sCO₂ gas turbine cycle with recuperation and recompression, which provides a baseline for performance of a standalone sCO₂ gas turbine cycle. FIG. 6 shows the schematic of a sCO₂ gas turbine cycle system 600 with recuperation and recompression. Initially, 60% of CO₂ at a pressure of 7.5 MPa and a temperature of 300 K enters system 600 at State 1 where it is compressed in first compressor 602 to a higher pressure and reaches State 2. Meanwhile, the rest of the CO₂ at the same pressure but higher temperature is compressed in second compressor 604 and reaches State 2a. The initial CO₂ from State 2 is preheated in low temperature recuperator 606 and reaches State B1 where the two CO₂ streams combine. The complete stream is then further preheated in high temperature recuperator 608 and reaches State 3. Here, heat is added from external sources like fossil fuels or solar energy via heat input heat exchanger 610 and reaches State 4. In this analysis, the heat is added by the combustion of methane. Power is extracted from the CO₂ stream from State 4 to State 5 in turbine 612. The turbine exit stream then is used to preheat the incoming CO₂ streams in high temperature recuperator 608 reaching State 5a and in low temperature recuperator 606 reaching State 6. 60% of this stream rejects heat to the environment in precooler 614 for external purposes like process heating whereby it reaches State 1. The efficiency of the standard sCO₂ cycle (η_{SSGT}) given in FIG. 6 is represented in (27). In (27), \dot{m}_{CO}_{₂} is the is the mass flow rate of CO₂ in the cycle, h₄, h₅, h₂ₐ, h₆, h₂ and h₁ are the mass specific enthalpies of the States 4, 5, 2a, 6, 2, and 1, respectively. \dot{m}_{f} is the mass flow rate of methane required for providing necessary heat and HHV_{f} is the higher heating value of methane.

$${η}_{S S G T} = {\dot{m}}_{C {O}_{2}} \frac{( {h}_{4} - {h}_{5} ) - 0.4 ( {h}_{2 a} - {h}_{6} ) - 0.6 ( {h}_{2} - {h}_{1} )}{{\dot{m}}_{f} H H {V}_{f}} \qquad ( 27 )$$

Flame-assisted fuel cells. This section provides a theoretical model of FFC. For this analysis, calculations in all the subsequent sections are done at a specific equivalence ratio. Equivalence ratio (Φ) is defined as shown in (28). In (28), n_{fuel} and n_{Ox} represent molar flow rates of fuel and oxygen, respectively. The superscript capital S in the molar flow rate terms in the denominator represent the molar flow rates required for stoichiometric reaction. Thus, when Φ>1, it represents fuel-rich combustion, when Φ<1, it represents fuel-lean combustion and when Φ=1, it represents stoichiometric combustion.

$$Φ = \frac{\frac{{n}_{f u e l}}{{n}_{ox}}}{\frac{{n}_{f u e l}^{s}}{{n}_{ox}^{s}}} \qquad ( 28 )$$

FIG. 7 shows the schematic of FFC system 700 with various reaction zones. FFC system 700 includes fuel stack 701 with fuel cells 702 in tubular form. Each fuel cell 702 includes porous anode 704 and cathode 706 separated by dense electrolyte layer 708. Anode 704 and cathode 706 have high ionic and electronic conductivity whereas electrolyte 708 has no electronic conductivity, but high ionic conductivity. Partial oxidation of the fuel and oxygen mixture sent to fuel-rich combustion pre-burner 710 results in the generation of syngas (CO+H₂). This syngas then diffuses into anode 704 where it reacts with the oxygen ion coming from the cathode 706 side through electrolyte 708 to form carbon dioxide and water. After fuel cell 702, the remaining syngas is then combusted with excess oxygen in the fuel-lean combustion after-burner 712 to generate heat. The exhaust of after-burner 712 is let out of the FFC system 700. The overall FFC system generates heat in every step of fuel-rich combustion, fuel cell electrochemical oxidation and fuel-lean combustion.

The first reaction is the fuel-rich combustion of methane in oxygen. This reaction is shown in (29). In (29), Φ is the equivalence ratio of the fuel-rich combustion reaction. The coefficients of the products of fuel-rich combustion i.e. a, b, c, d and γ are calculated using chemical equilibrium and element balance.

ΦCH₄+γ(O₂)→aCO+bH₂+cCO₂+dH₂O (29)

The enthalpy released by the fuel-rich combustion reaction (ΔH_{RC}) can be calculated as shown in (30), where \dot{m} is the mass flow rate and h_{f} is the specific enthalpy of formation of the respective species.

ΔH_{RC}=\dot{m}_{CO}h_{CO,1073K}+\dot{m}_{CO}_{₂}h_{CO}_{₂}_{,1073K}+\dot{m}_{H}_{₂}_{O}h_{H}_{₂}_{O,1073K}+\dot{m}_{H}_{₂}_{,1073K}−\dot{m}_{CH}_{₄}h_{CH}_{₄}_{,298K} (30)

Various losses give rise to three main types efficiencies to consider in the FFC system. Those include the fuel utilization efficiency (η_{fu}), the fuel cell conversion efficiency (η_{fc}) and the overall efficiency (ηₒᵥ). They are described in the equations (32), (32) and (33) respectively.

$$\begin{matrix}{η}_{fu} = \frac{Syngas electrochemically oxidized in FFC}{Total Syngas available in exhaust} & ( 31 ) \\ {η}_{fc} = \frac{Electrical Power generated by FFC}{Total Chemical energy of the available syngas } & ( 32 ) \\ {η}_{ov} = \frac{Electrical power generated by fuel cell}{Chemical energy from the hydrocarbon fuel} & ( 33 )\end{matrix}$$

FFC employs the electrochemical oxidation of both CO and H₂ for generation of electric power. The effective fuel cell reaction is shown in (34). In (34), the coefficients a₁, b₁ and γ₁ depend upon the coefficients a, b and γ from (29) and the fuel utilization efficiency of the FFC.

a₁CO+b₁H₂+γ₁O₂→a₁CO₂+b₁H₂O (34)

The power generated by the fuel cell (Pfc) is shown in (35). In (35), η_{fu} is the fuel utilization efficiency, η_{fc} is the fuel cell efficiency and ΔG_{FC} is the total Gibbs' free energy released by the fuel cell reaction in (34).

P_{fc}=−η_{fu}·η_{fc}·ΔG_{FC} (35)

The total heat released by the fuel cell reactions is shown in (36). In (36), ΔH_{FC} is the total enthalpy released by the fuel cell reactions in (34).

H_{fc}=−η_{fu}·(1−η_{fc})·ΔH_{FC} (36)

After the fuel cell, the remaining fuel passes into the fuel-lean combustion chamber to generate heat which sustains the fuel cell temperature and adds further thermal energy for the SCO₂ stream. The fuel-lean combustion reaction is shown in (37). In (37), The coefficients a₂, b₂ and γ₂ depend upon the coefficients a, b, γ from (29) and the fuel utilization efficiency such that if a moles of CO and b moles of H₂ are produced in fuel-rich combustion and a₁ and b₁ moles of CO and H₂ respectively react in the fuel cell reaction, then a₂ equals the difference between a and a₁ and b₂ equals the difference between b and b₁. γ₂ is based upon the equivalence ratio of the fuel-lean combustion. The CO₂ and H₂O generated in the fuel-rich combustion, FFC and the fuel-lean combustion reactions are assumed to remain unreacted throughout the system.

a₂CO+b₂H₂+γ₂O₂→a₂CO₂+b₂H₂O (37)

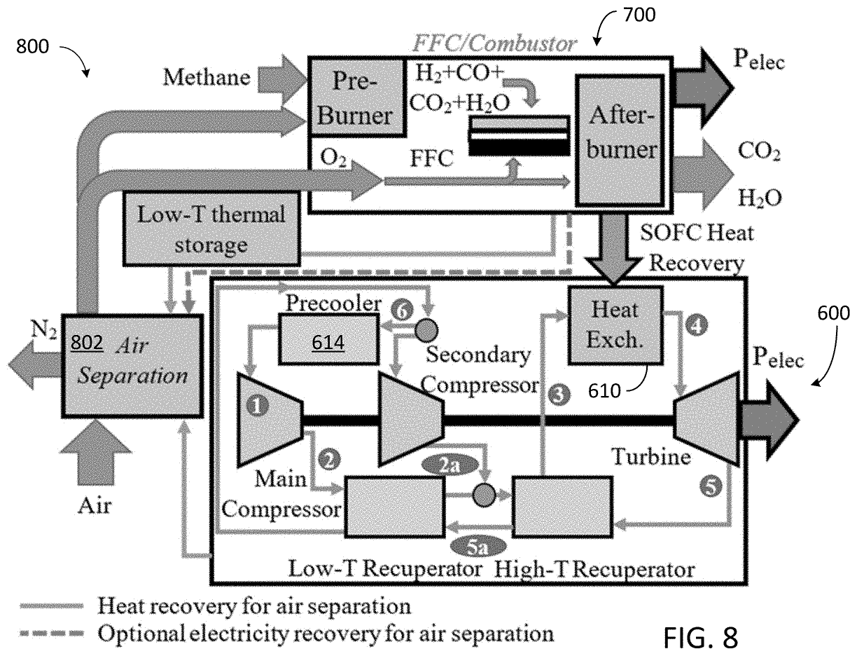

FFC SCO₂ gas turbine hybrid with optional carbon sequestration. FIG. 8 shows a schematic of FFC sCO₂ gas turbine hybrid system 800 including sCO₂ gas turbine cycle system 600 and FFC system 700. In system 800, sCO₂ gas turbine system 600 receives heat input from FFC system 700 via heat exchanger 610. System 800 has an option of carbon sequestration via air separation unit 804 which separates the nitrogen and oxygen from the air and provides the oxygen to FFC system 700 for pre-burner, fuel cell and after-burner operation. The resulting exhaust from FFC system 700 typically requires water removal and compression to be sequestration ready. System 800 has higher total system efficiency and a tunable power to heat ratio, and can be configured as a zero emissions combined heat and power (CHP) unit. Use of FFC system 700 instead of a conventional SOFC leads to significant reduction in complexity and weight of the overall system. Another advantage of system 800 is the number of parameters that can be altered, like the conditions of fuel-rich combustion, the FFC, air separator 804 or the sCO₂ system 600 in order to achieve higher power to heat ratios, higher electrical efficiencies and higher thermal efficiencies. One advantage of the system is that the heat rejected from the precooler 614 can be used to provide heat for air separation unit 802 thus making system 800 self-sustained and powered by a single fuel source. States 1-6 of the sCO₂ cycle correspond to those shown in FIG. 6, with the addition of FFC system 700 and air separation unit 804. The electrical efficiency of system 800 is given by (38). In (38), P_{FFC} is the part of total power generated by FFC, P_{CO}_{₂}_{GT} is the part of total power generated by sCO₂ gas turbine cycle.

$${η}_{F F C G T} = \frac{{P}_{F F C} + {P}_{{CO}_{2} G T}}{{\dot{m}}_{f} H H {V}_{f}} \qquad ( 38 )$$

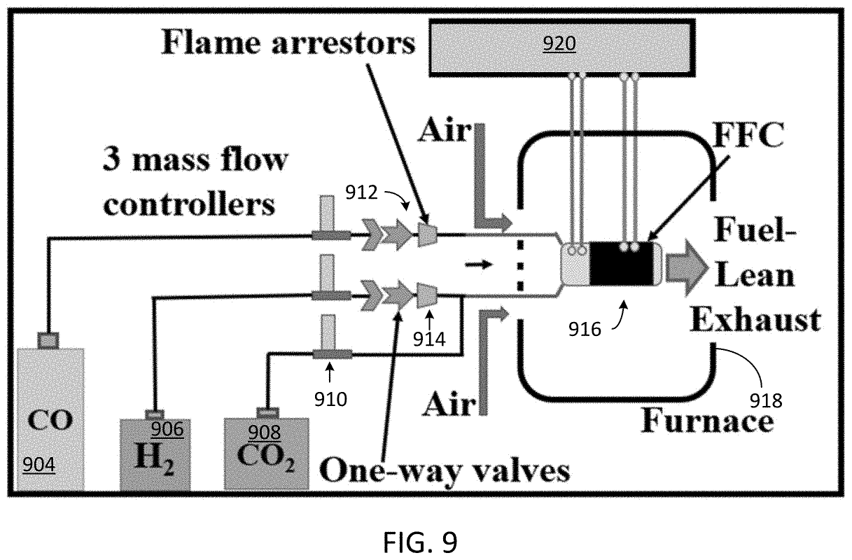

Experimental. An experiment was set up to evaluate the performance of the fuel cell with model exhaust. FIG. 9 shows a schematic of an experimental FFC sCO₂ gas turbine hybrid system 900. The experiment was performed with model dry exhaust of combustion of methane in oxygen (i.e. carbon monoxide 904, hydrogen 906, and carbon dioxide 908. Due to the difficulty of working with steam and the assumption of non-reactivity of steam in the experiment, the steam flow rate was added to carbon dioxide flow rate in the experiment. The flow rates of the individual species were calculated using chemical equilibrium. Mass flow controllers 910 were used to regulate the flow of these gases. The fuel lines of carbon monoxide and hydrogen were connected through one-way valves 912 to flame arrestors 914 to avoid flashback. The flow rates of these gases were calculated using NASA CEA exhaust compositions for a constant inlet fuel flow rate of 0.066 mg·s⁻¹.

The NASA CEA exhaust composition for combustion of methane in air is shown in Table 4. The volumetric flow rate of species ‘i’ was calculated using (39) at various equivalence ratios in the units of ml·min⁻¹. In (39), Xᵢ is the mole fraction of species ‘i’ obtained from Table 4 at the respective equivalence ratio. X_{CO} and X_{CO2} are the mole fractions of CO and CO₂ respectively at corresponding equivalence ratio and Vₘₒₗ is the molar volume of ideal gas at 298 K, 1 Bar pressure. The flow rates subsequently obtained are shown in Table 5. The gases were all mixed and sent to FFC 916 inside furnace 918 at 1073 K. A sourcemeter 920 (Keithley 2460) was connected to anode 704 and cathode 706 of FFC 702 using current collectors to measure the data. A current-voltage method with a 4-probe technique was used to obtain the results. In a 4-probe method, a high impedance current source is used to supply current through 2 outer probes whereby a voltmeter measures the voltage across 2 inner probes to determine the power density. Air from cathode 706 is taken directly from the environment as shown in FIG. 9.

$${V}_{i} = \frac{{\dot{n}}_{f}}{( \frac{{X}_{CO} + {X}_{{CO}_{2}}}{12} )} * {X}_{i} * 60 * {V}_{m o l} \qquad ( 39 )$$

TABLE 4
NASA CEA exhaust composition of methane
in oxygen for different equivalence ratios

| Equivalence | | | |
|---|---|---|---|
| ratio | CO | H₂ | CO₂ |
| 1.20 | 0.20 | 0.11 | 0.45 |
| 1.40 | 0.23 | 0.16 | 0.43 |
| 1.60 | 0.25 | 0.21 | 0.40 |
| 1.80 | 0.27 | 0.28 | 0.36 |
| 2.00 | 0.29 | 0.34 | 0.31 |
| 2.20 | 0.30 | 0.40 | 0.26 |
| 2.40 | 0.31 | 0.46 | 0.22 |
| 2.60 | 0.31 | 0.50 | 0.18 |
| 2.80 | 0.32 | 0.54 | 0.14 |

TABLE 5
Flow rates of gases used in the experiment
at different equivalence ratios

| Equivalence | CO | H₂ | CO₂ | Total |
|---|---|---|---|---|
| ratio | (ml · min⁻¹) | (ml · min⁻¹) | (ml · min⁻¹) | (ml · min⁻¹) |
| 1.20 | 3.33 | 1.94 | 7.18 | 12.45 |
| 1.40 | 3.81 | 2.68 | 6.87 | 13.36 |
| 1.60 | 4.22 | 3.55 | 6.40 | 14.17 |
| 1.80 | 4.55 | 4.55 | 5.78 | 14.88 |
| 2.00 | 4.82 | 5.59 | 5.06 | 15.47 |
| 2.20 | 5.00 | 6.61 | 4.33 | 15.94 |
| 2.40 | 5.15 | 7.51 | 3.63 | 16.29 |
| 2.60 | 5.25 | 8.28 | 2.96 | 16.49 |
| 2.80 | 5.32 | 8.93 | 2.38 | 16.63 |

Fuel cell fabrication. Fabrication of the FFC anode (NiO+YSZ, (Y₂O₃)_{0.08}(ZrO₂)_{0.92}) and electrolyte (YSZ, ˜22 μm thick) was previously described. The anode was pre-fired at 1373 K. The electrolyte was dip coated on the anode. A buffer layer of Sm_{0.20}Ce_{0.80}O_{2-X} (SDC) was deposited onto the (YSZ) electrolyte using spray deposition. Drying and sintering was done at 1673 K for 4 h. An SDC+LSCF (La_{0.60}Sr_{0.40})_{0.95}Co_{0.20}Fe_{0.80}O_{3-X}) cathode was deposited onto the buffer layer using dip coating and was later dried and sintered at 1373 K for 2 hours. Silver wire and silver paste were used as current collector on the cathode and anode. The total active area of the cell is 4.32 cm².

Fuel cell performance. The performance of the FFC operating at 1073 K with a model fuel-rich combustion exhaust composition between the equivalence ratios of 1.2 to 2.8 was assessed. Significant power densities were achieved at all equivalence ratios. As equivalence ratio increases, the open circuit voltage across the cell increases. At lower current densities, the slope of the voltage curves remains the same at all equivalence ratios. At these current densities, the ohmic loss dominates and since the resistance of the materials is largely independent of the equivalence ratio, this loss is constant. At larger current densities, the voltage decays at a faster rate as equivalence ratio decreases. This happens because as the equivalence ratio decreases, the concentration of the syngas in the combustion exhaust decreases as can be seen from Table 4, leading to higher concentration losses at lower equivalence ratios which leads to this rapid decay. The activation loss is negligible across all equivalence ratios. The maximum power density reached increases as the equivalence ratio increases. This happens because as the equivalence ratio increases, more syngas is available in the model exhaust leading to larger Gibbs' free energy released which in turn leads to more total power being generated in the FFC. At an operating voltage of 0.6 V, the maximum power density of 183 mW·cm⁻² was reached at an equivalence ratio of 2.8. The fuel utilization efficiencies reached was 75% at an equivalence ratio of 1.2 to 63% at an equivalence ratio of 2.8 at an operating voltage of 0.6 V.

sCO₂ gas turbine performance with and without the FFC integrated. The computation for the sCO₂ gas turbine calculations was done assuming that the experimental FFC will perform in the same way as it did during the experiment when scaled to the design power. To isolate the effects of integrating FFC with the standard sCO₂ cycle, the total power generated by the gas turbine system alone was held constant at 6 MW. For generating this power, the temperatures and pressures of various state points from FIG. 6 are shown in Table 6. The mass flow rate of CO₂ required for generating 6 MW power with the state points given in Table 6 is 47.66 kg/s. The compression ratio in the system is 2.66. Using the state points from Table 6 and the mass flow rate of CO₂ in the cycle, the total enthalpy required to be transferred to the sCO₂ cycle by the heat source (FFC in this case) is calculated to be 10.64 MW. Thus, the performance of integrating a FFC stack that is that is able to provide the heat required by sCO₂ cycle is evaluated.

TABLE 6
Temperatures and pressures of the state points in sCO₂ cycle

| | Temperature | Pressure |
|---|---|---|
| State point | (K) | (MPa) |
| 1 | 300 | 7.5 |
| 2 | 318 | 20 |
| 2a | 414 | 20 |
| 3 | 733 | 20 |
| 4 | 913 | 20 |
| 5 | 780 | 7.5 |
| 5a | 452 | 7.5 |
| 6 | 331 | 7.5 |

The air or oxygen required for the FFC functioning was assumed to be at 1 bar and 298 K. The fuel-rich equivalence ratio of the FFC is varied while the fuel-lean equivalence ratio of the FFC is kept constant at 0.8. The heat exchangers in the system are assumed to be 90% efficient. η_{FU} and η_{FC} (0.7 and 0.5, respectively) are taken directly from experimental results as the average of all equivalence ratios. As the equivalence ratio increases, the amount of methane required to provide the necessary heat increases for both air and oxygen case. This happens because as the equivalence ratio increases, a larger portion of the incoming fuel energy is converted into electric power and thus to make up for it, more fuel needs to be supplied in order to meet the heat requirement. It can also be seen that the fuel required to meet the heat requirement is much higher for air case than with oxygen. Since the temperature of the FFC setup is fixed (1073 K), more fuel is required to provide the fuel-rich combustion products at that temperature with air than with oxygen. This happens because a large portion of the fuel-rich exhaust with air contains nitrogen which acts as a heat sink reducing the overall temperature and does not take part in heat generation in the setup. This nitrogen is absent in oxygen case leading to a more efficient use of the enthalpy released by fuel-rich combustion.

The power generated by various parts of the hybrid system with air and oxygen oxidizers was assessed. The power generated by the FFC integrated sCO₂ gas turbine increases with increase in equivalence ratio. This happens because with increase in equivalence ratio, the concentration of syngas in the fuel-rich combustion exhaust increases. The total power generated by the FFC integrated sCO₂ gas turbine setup with air is marginally greater than the power generated with oxygen. This happens in spite of the large amount of fuel flow required with air compared to oxygen to meet the necessary heat. This is primarily because only a small portion of the fuel-rich combustion exhaust with air contains syngas which can be electrochemically converted to power whereas a large portion of fuel-rich combustion exhaust with oxygen contains syngas. Close to the equivalence ratio of 1.2, the exhaust composition of methane with air leads to a lower flow rate of syngas compared to the flow rate of syngas with oxygen. At equivalence ratios close 1.2, the flow rate of syngas is lower with air compared to oxygen at corresponding methane flow rates and after equivalence ratio 1.4, the flow rate of syngas with air is greater than that with oxygen.

The electrical efficiency of the system with and without the FFC integrated with air and oxygen oxidizers was assessed. The electrical efficiency of the FFC integrated sCO₂ gas turbine setup is higher when operated with oxygen compared to air. This is primarily because of the low methane requirement with oxygen as oxidizer compared to air. Although the electrical power generated by the FFC integrated sCO₂ gas turbine setup with oxygen is slightly lower than with air, the fuel requirement with oxygen is much lower than that with air. This is the major reason for the difference in electrical efficiency. It can be seen that the electrical efficiency of the FFC integrated sCO₂ gas turbine setup with air is lower than the standard sCO₂ gas turbine setup at equivalence ratios below 1.8. This happens because at equivalence ratios below 1.8, the concentration of syngas in the fuel-rich combustion exhaust is low leading to low power generation in the fuel cell. Thus, the integration offers no real value when operated with air at equivalence ratios below 1.8. On the other hand, the electrical efficiency of the FFC integrated sCO₂ gas turbine setup with oxygen is higher than that standard sCO₂ gas turbine setup at all equivalence ratios. At the equivalence ratio of 2.8, the electrical efficiency of the FFC integrated sCO₂ gas turbine setup with oxygen is almost 20% higher than the standard sCO₂ gas turbine setup. Whereas with air, it is up to 8% higher at the equivalence ratio of 2.8. The oxygen case also has the benefit of carbon sequestration from the fuel-cell exhaust leading to a zero emissions, environmentally friendly power generation setup.

Since the system has an option of carbon sequestration, a self-reliant system can be used to provide the heat required for oxygen separation from air. The heat rejected by the system from the precooler can be used for this purpose. The power to heat ratio of the system is a factor in a reliable power source. Since the parameters of the sCO₂ cycle are constant, the heat rejected from the precooler is also constant at 9.01 MW. The power to heat ratio for the proposed system with and without the FFC integrated with oxygen and air oxidizer is shown was assessed. The power to heat ratio of the FFC integrated sCO₂ gas turbine setup is higher than the standard sCO₂ gas turbine setup at all equivalence ratios. This happens because the power generated by the FFC integrated setups is more than the power generated by setup without integrated FFC at all equivalence ratios while the heat rejected remains the same. Additionally, the power to heat ratio of the FFC integrated sCO₂ gas turbine setup is marginally higher with air compared to oxygen for equivalence ratios above 1.4. This happens because the power generated by the proposed setup with air is marginally higher than the power generated by the proposed setup with oxygen. Though, as mentioned earlier, the oxygen case provides an additional benefit of optional carbon sequestration which is not possible with air. Though the electrical efficiency of the FFC integrated sCO₂ with oxygen is higher than the standard sCO₂ gas turbine case, the heat rejected by the sCO₂ cycle is not enough to generate the required oxygen for the FFC operation. Due to this, it is important to tune the FFC parameters to meet the oxygen requirements of the FFC.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A flame-assisted fuel cell gas turbine hybrid system comprising:
a first combustor;
a second combustor; and
a flame-assisted solid oxide fuel cell configured to receive syngas from the first combustor, react the syngas with oxygen ions to yield carbon dioxide and water, and provide unreacted syngas to the second combustor,
wherein the first combustor is configured to receive heated compressed air from an aircraft engine compressor and the second combustor is configured to provide heated air to an aircraft engine gas turbine to generate mechanical power.

2. The system of claim 1, further comprising the aircraft engine compressor.

3. The system of claim 1, further comprising the aircraft engine gas turbine.

4. The system of claim 1, wherein the first combustor is configured to combust jet fuel.

5. The system of claim 1, further comprising a heat exchanger configured to provide cooling air to the first combustor, the second combustor, and the flame-assisted fuel cell.

6. The system of claim 1, further comprising a recuperator configured to heat the compressed air from the airplane engine compressor to yield the heated compressed air.

7. The system of claim 6, wherein the recuperator is configured to heat the compressed air from the airplane engine compressor with exhaust from the aircraft engine turbine.

8. The system of claim 1, wherein the system is configured to convert jet fuel to electricity and to heat.

9. The system of claim 1, wherein the system is free of a reformer.

10. The system of claim 1, wherein the flame-assisted solid oxide fuel cell has a tubular configuration.

11. A method of generating electricity and heat from jet fuel, the method comprising:
providing jet fuel and compressed air from an aircraft engine compressor to a first combustor;
combusting the jet fuel in the first combustor to yield syngas;
reacting the syngas in a flame-assisted solid oxide fuel cell to generate electricity and yield carbon dioxide and water; and
providing unreacted syngas from the first combustor to a second combustor to generate heat.

12. The method of claim 11, further comprising providing the heat from the second combustor to an aircraft engine turbine.

13. The method of claim 12, further comprising providing exhaust from the aircraft engine turbine to a recuperator.

14. The method of claim 13, further comprising heating the compressed air from the aircraft engine compressor with the exhaust from the aircraft engine turbine.

15. The method of claim 11, wherein the jet fuel is in a stoichiometric excess relative to oxygen in the first combustor.

16. The method of claim 11, wherein the unreacted syngas is in a stoichiometric deficit relative to oxygen in the second combustor.

17. The method of claim 11, wherein heat addition to the system occurs in the first combustor, the flame-assisted solid oxide fuel cell, and the second combustor.

18. The method of claim 11, further comprising cooling the first combustor, the flame-assisted solid oxide fuel cell, and the second combustor with air from the aircraft engine compressor.

19. The method of claim 11, further comprising providing the heat to the aircraft engine gas turbine.

20. The method of claim 11, wherein generating the electricity and the heat from the jet fuel is achieved in the absence of a fuel reformer.
